(19) United States
(12) Patent Application Publication
(10) Pub. No.: US 2015/0030741 A1
(43) Pub. Date: Jan. 29, 2015

(54) SYSTEM FOR APPLYING PATTERNED CRUST SEGMENTS TO DOUGH

(71) Applicant: Michael C. FINDLAY, Corona, NY (US)

(72) Inventor: Michael C. FINDLAY, Corona, NY (US)

(21) Appl. No.: 13/949,431

(22) Filed: Jul. 24, 2013

(51) Int. Cl. A21C 11/06; B29C 59/02

(52) U.S. Cl. CPC A21C 11/06; B29C 59/02
USPC 426/496; 425/385

(57) ABSTRACT

A device and method to create additional segments of crust and topping zones on baked products such as pizza. The device is a base with a top surface and a bottom surface opposing the top surface and at least one pattern that protrudes from the surface of the base. Before cooking the baked product, the pattern is embossed into uncooked dough. Additional dough may be applied along the pattern on the flattened uncooked dough along the embossed pattern. The newly created crust results in additional segments of crust and topping zones throughout the pizza. Within the new topping zones, singular or combinations of toppings can be applied. Once baked, the product may be sliced along the crust segments, with each individual slice having toppings and a crust section.

### CROSS-REFERENCE TO RELATED APPLICATION

This application claims priority to provisional patent application No. 61/741,998 filed on Aug. 1, 2012.

### FEDERALLY SPONSORED RESEARCH

Not Applicable

### SEQUENCE LISTING OR PROGRAM

Not Applicable

### BACKGROUND

The present application is related to the creation of crust segments in baked products. Baked products such as pizza traditionally have a raised crust along their perimeter. Traditionally, the crust is created when sauce and toppings are dispersed on stretched or flattened dough while leaving the dough perimeter free of sauce and toppings. When the dough is baked, the areas where no sauce and toppings are applied expand to a greater degree than the remaining dough, creating a raised perimeter of crust with a central zone of sauce and toppings.

The traditional method of creating a crust for pizza results in a central topping zone where sauce, cheese and one or more toppings may be dispersed. When multiple toppings are placed onto the uncooked pizza, they are either mixed together or manually separated on the central topping zone. For example, a pizza may have Topping A on one half, and Topping B on the other half. The cooked pizza is then cut into slices with each slice having a mixture of toppings, or with each slice having only the toppings from the central zone from which it was sliced. With a round pizza, each pie-shaped slice is adjacent to the perimeter of the pizza and thus comprises a crust. With a square or rectangular pizza, slices that are not adjacent to the perimeter of the pizza do not have a crust.

It is desirable to have a better system for creating additional segments of crust and topping zones on baked products such as pizza so that each slice may comprise a crust. The solution is found in the present disclosure for a device and method for applying additional crust segments to dough. The device comprises a base with a top surface and a bottom surface and at least one protruding pattern, where the pattern is transferred into the dough by pressing the device onto flattened dough, removing the device, and then applying more dough to create additional segments of crust and topping zones.

### SUMMARY

The present disclosure is directed to a device and method that satisfies this need for creating additional segments of crust and topping zones on baked products such as pizza. The device comprises a base with a top surface and a bottom surface opposing the top surface and at least one pattern protruding from the surface of the base. Prior to cooking the baked product, the pattern is embossed into flattened dough and then additional dough is applied along the pattern on the flattened dough, creating additional segments of crust and topping zones throughout the baked product.

The creation of additional crust segments results in segregated zones where singular or combinations of toppings can be applied. When the baked product such as pizza is cooked and sliced along the crust segments, each individual slice of pizza comprises toppings and a crust section.

### DRAWINGS

FIG. 1 illustrates a top plan view of a device embodying features of the present invention of a system for applying additional crust segments to dough.

FIG. 2 illustrates a perspective sectional view of an alternative embodiment of a handle embodying features of the present invention for system for applying additional crust segments to dough.

FIG. 3 illustrates a perspective sectional view of an alternative embodiment of a handle embodying features of the present invention for system for applying additional crust segments to dough.

FIG. 4 illustrates a perspective view of applying a device embodying features of the present invention for system for applying additional crust segments to dough.

FIG. 5 illustrates a perspective view of removing a device embodying features of the present invention for system for applying additional crust segments to dough.

FIG. 6 illustrates a top plan view of a flattened sheet of dough after application of crust segments embodying features of the present invention for system for applying additional crust segments to dough.

FIG. 7 illustrates a top plan view of a pizza with additional topping zones and crust segments embodying features of the present invention for system for applying additional crust segments to dough.

FIG. 8A illustrates a top plan view of an alternate embodiment of a device embodying features of the present invention.

FIG. 8B illustrates a top plan view of a pizza with additional topping zones and crust segments embodying features of the present invention.

FIG. 9A illustrates a top plan view of an alternate embodiment of a device embodying features of the present invention.

FIG. 9B illustrates a top plan view of a pizza with additional topping zones and crust segments embodying features of the present invention.

FIG. 10A illustrates a top plan view of an alternate embodiment of a device embodying features of the present invention.

FIG. 10B illustrates a top plan view of a pizza with additional topping zones and crust segments embodying features of the present invention.

FIG. 11A illustrates a top plan view of an alternate embodiment of a device embodying features of the present invention.

FIG. 11B illustrates a top plan view of a pizza with additional topping zones and crust segments embodying features of the present invention.

FIG. 12A illustrates a top plan view of an alternate embodiment of a device embodying features of the present invention.

FIG. 12B illustrates a top plan view of a pizza with additional topping zones and crust segments embodying features of the present invention.

FIG. 13A illustrates a top plan view of an alternate embodiment of a device embodying features of the present invention.

FIG. 13B illustrates a top plan view of a pizza with additional topping zones and crust segments embodying features of the present invention.

### DESCRIPTION

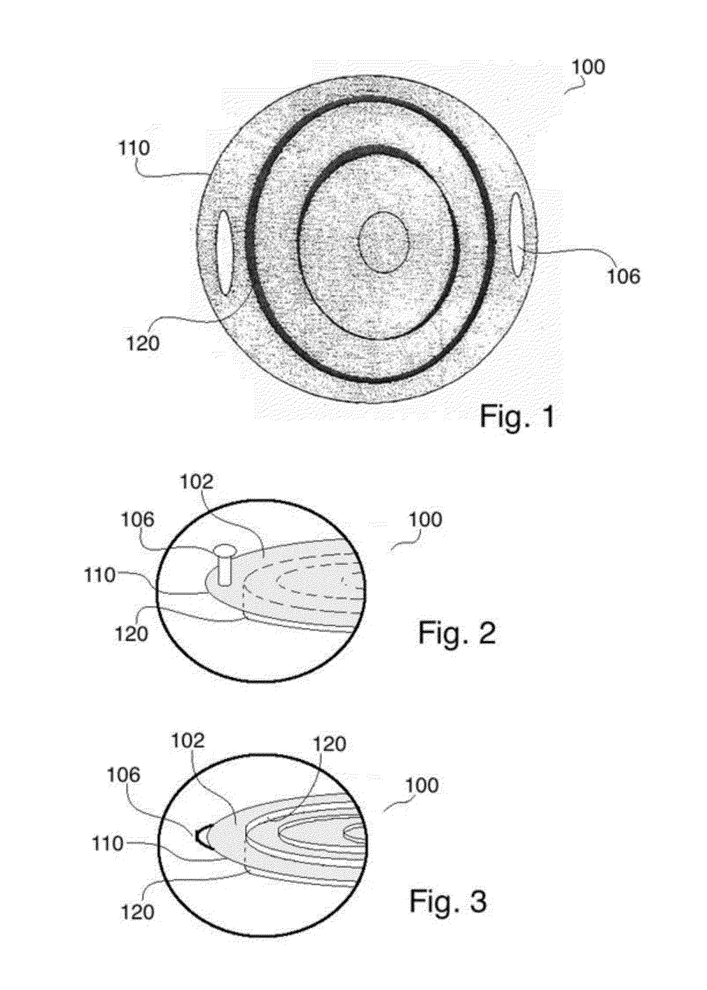

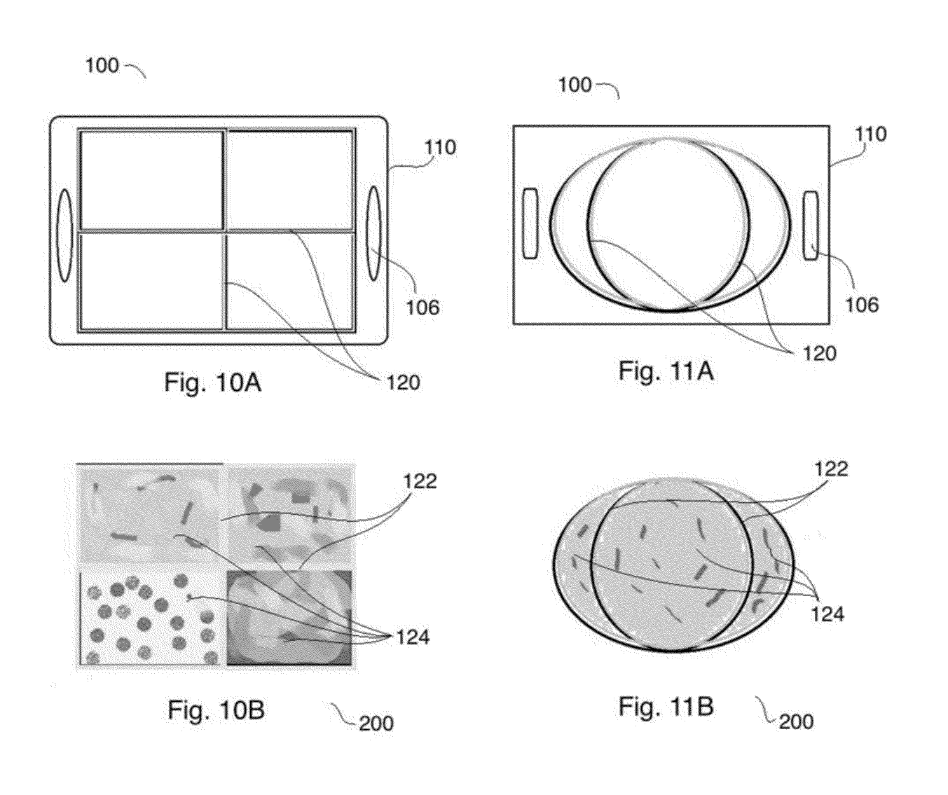

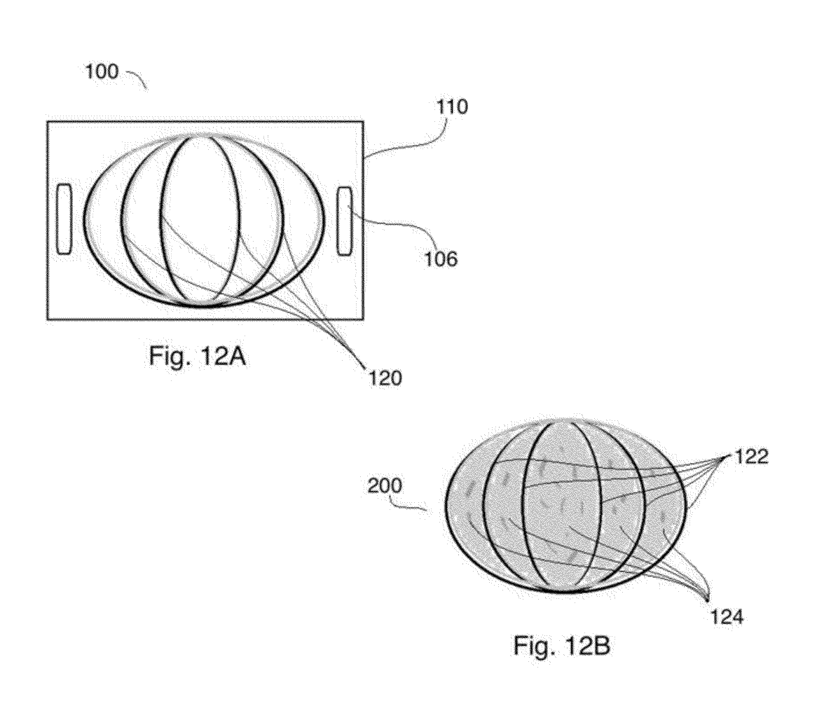

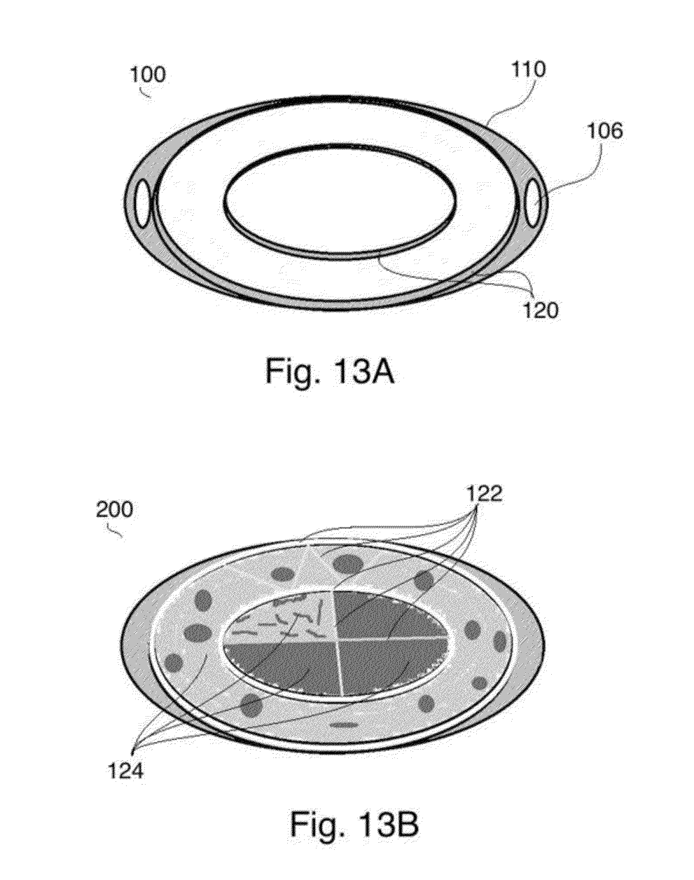

As shown in FIGS. 1-12B, a “system for applying additional crust segments to dough” 100 comprises a base 110 with a top surface 102 and a bottom surface 104 opposing the top surface, a pattern 120 protruding from a surface of the base 110, and optional handles 106.

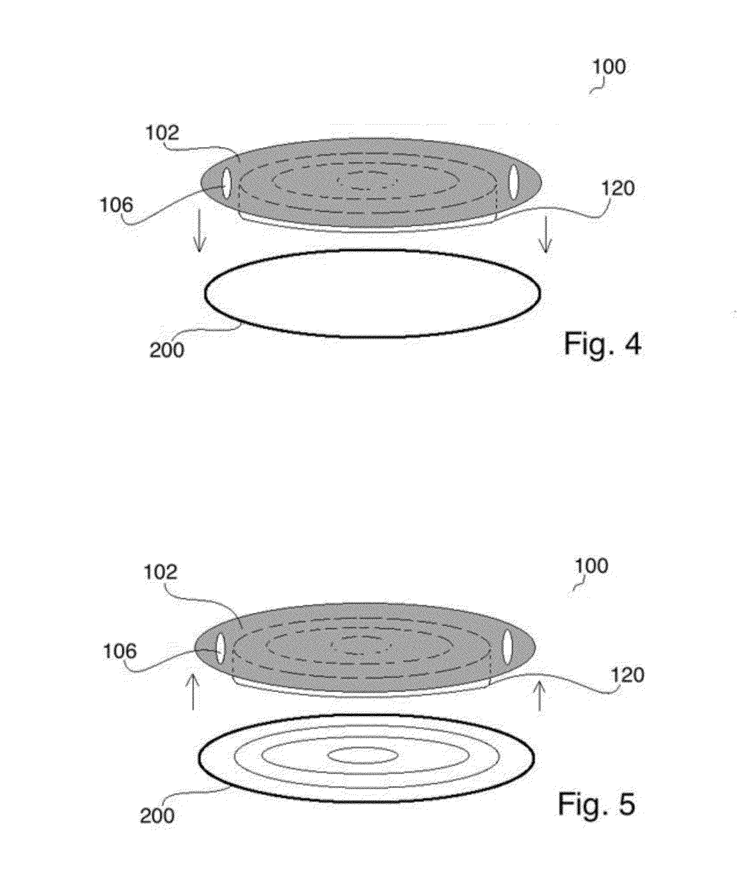

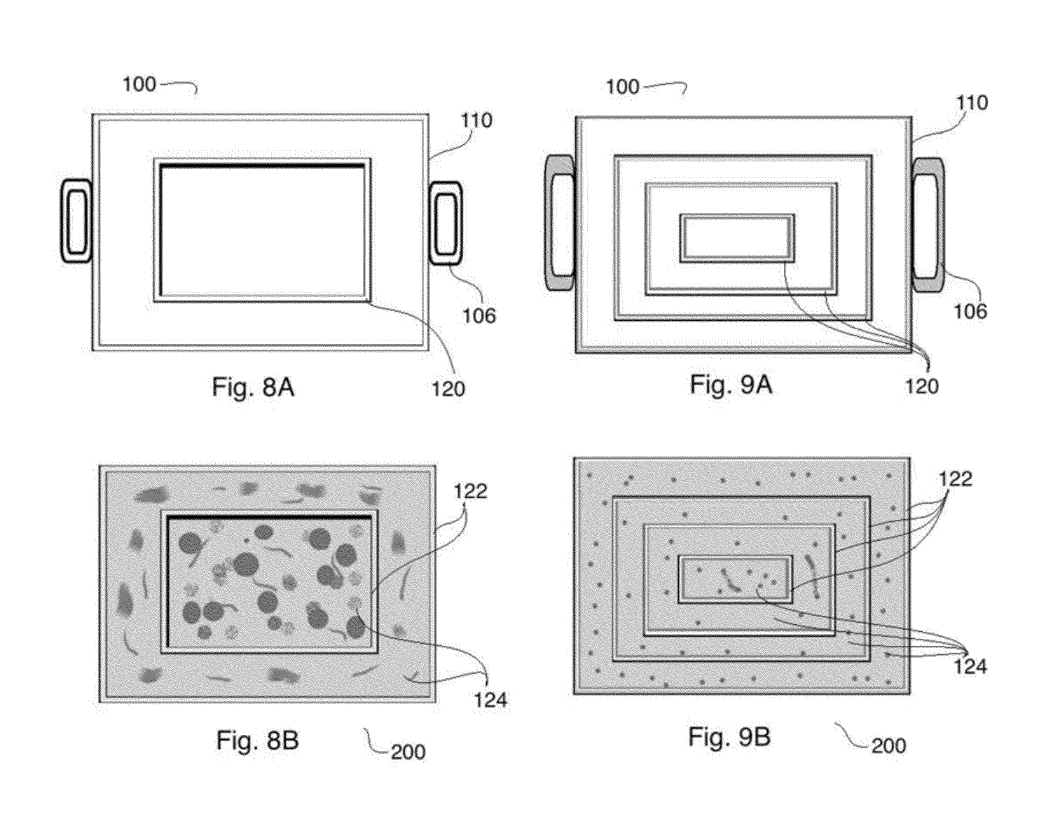

As illustrated in FIG. 1, the base 110 provides a surface for the pattern 120 to either protrude from or be imprinted. The base also allows the system for applying additional crust segments to dough 100 to be applied to uncooked dough 200 evenly, using the optional handles 106, as illustrated in FIGS. 4-5. The base 110 and pattern 120 may be any regular or irregular shape, including round, square, or rectangular, as shown in FIGS. 8A, 9A, 10A, 11A, and 12A. In an alternative embodiment, the base 110 may comprise a convex surface from which the pattern 120 protrudes, allowing the system for applying additional crust segments to dough 100 to be rolled over uncooked dough 200. The width and length of the base 110 may vary depending on the size and shape of the pattern 120 to be applied to uncooked dough 200. For larger uncooked dough 200, the base 110 will have a larger surface area. Alternatively, a smaller base size can be used repeatedly on a larger dough area. The base 110 may be made of any natural or synthetic material of suitable rigidity for using the device 100 to apply a pattern 120 to uncooked dough 200, such as metal, wood, plastic, or silicone.

The pattern 120 is used to emboss and flattened uncooked dough 200 for the creation of additional crust segments 122 and topping zones 124 as shown in FIGS. 4-5. The shape of the base 110 and pattern 120 determine the resulting crust segments 122 and topping zones 124 as can be seen in FIGS. 8A-12B. As best illustrated in FIG. 2, the pattern 120 preferably protrudes from one side of the base 110. Alternatively, a second pattern may protrude from the opposite side of the base 110 as illustrated in FIG. 3, allowing for a several different patterns 120 shapes or sizes on one base 110. The pattern 120 can be any shape of desired crust ring, including circle, round, square. Where multiple patterns 120 are used, the patterns 120 may be formed in subsequently smaller rings as illustrated in FIG. 1, or repeated upon the base 110. The pattern 120 height is preferable less then the thickness of the uncooked dough 200 thickness. The pattern 120 width may vary depending on the desired embossment width, or crust width desired. Like the base 110, the pattern 120 may also be made from any natural or synthetic material of suitable rigidity for using the system for applying additional crust segments to dough 100 to apply a pattern to dough, such as metal, wood, plastic, or silicone.

In an alternate embodiment, the pattern 120 protruding from the base 110 may be used to create the topping zones 120 into the dough such that the concaved areas in the pattern 120 create the additional crust 122 segments. In yet another alternate embodiment, the distal end of the pattern 120 may have a textured surface so that a texture remains in the uncooked dough 200 after use of the system for applying additional crust segments to dough 100. This texture allows for better adhesion between the uncooked dough 200 and newly added crust segments 122.

Handles, as illustrated in FIGS. 1-3 may be added or incorporated into the base 110. The handles 106 may be in the form of elongated holes through the base 110. Alternatively, the handles 106 may extend from a surface of the base 110. FIG. 2 illustrates a distal handles extending from the surface of the base 110 opposite of the surface with the pattern 120. FIG. 3 illustrates a handle 106 extending from the side of the base 110. The handles 106 of FIG. 1 or 3 are preferred where the base has a pattern 120 on several surfaces.

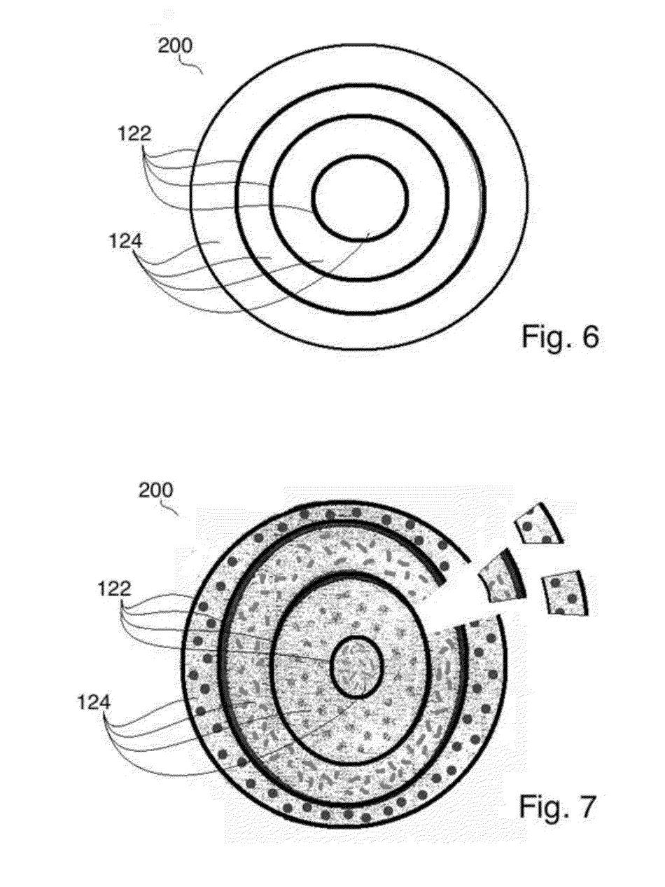

The system for applying additional crust segments to dough 100 is used by first placing the base 110 over uncooked dough 200 with the pattern 120 toward the uncooked dough 200 as illustrated in FIG. 4. The uncooked dough 200 may be flattened prior to use of the system for applying additional crust segments to dough 100, or flattened when the base 110 with pattern 120 is applied to the dough. As illustrated in FIGS. 4-5, the base 110 is evenly pressed into the uncooked dough 200 and then raised away from the uncooked dough 200 and set aside. The uncooked dough 200, now having a pattern embossed onto it, is ready for additional crust segments 122 to be applied. Additional crust segments 122 in the form of uncooked dough 200 are applied to the embossed pattern in the flattened uncooked dough as shown in FIG. 6, creating topping zones 124. Referring to FIG. 7, toppings are then applied to the area of dough between the crust segments 122. Once baked, the pizza can be cut along the crust so that each slice comprises an adjacent crust.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1. A method for creating a pizza with additional patterned crust segments utilizing a device for applying patterned crust segments to dough, comprising the steps of:
(a) placing a base with a raised or concaved pattern over uncooked dough with the pattern facing the dough,
(b) pressing the base with the pattern into the dough,
(c) removing the base with the pattern; and
(d) applying crust segments to the dough wherein a piece or pieces of dough are disposed along borders formed by the pattern in the dough.

2. A device for applying patterned crust segments to dough, the device comprising:
(a) a base with a top surface and a bottom surface opposing the top surface, wherein at least one pattern protrudes from at least one of the base surfaces.

3. The device for applying patterned crust segments to dough as defined in claim 2, wherein the base comprises a circular plane.

4. The device for applying patterned crust segments to dough as defined in claim 2, wherein the base comprises a rectangular plane.

5. The device for applying patterned crust segments to dough as defined in claim 2, wherein the base comprises at least one handle.

6. The device for applying patterned crust segments to dough as defined in claim 4, wherein the at least one handle distally extends from the base.

7. The device for applying patterned crust segments to dough as defined in claim 4, wherein the at least one handle is a hole through the base.

8. The device for applying patterned crust segments to dough as defined in claim 2, wherein the at least one pattern protrudes from the bottom side of the base.

9. The device for applying patterned crust segments to dough as defined in claim 2, wherein the at least one pattern protrudes from the top and bottom side of the base.

10. The device for applying patterned crust segments to dough as defined in claim 2, wherein the at least one pattern protruding from the base comprises varying sizes.

11. The device for applying patterned crust segments to dough as defined in claim 2, wherein the at least one pattern protruding from the base comprises a circle.

12. The device for applying patterned crust segments to dough as defined in claim 2, wherein the at least one pattern protruding from the base comprises a rectangle.

13. The device for applying patterned crust segments to dough as defined in claim 2, wherein the at least one pattern protruding from the base comprises a textured distal end.
